(19) United States
(12) Patent Application Publication
(10) Pub. No.: US 2026/0070330 A1
(43) Pub. Date: Mar. 12, 2026

(54) LIQUID EJECTION HEAD AND LIQUID EJECTION APPARATUS

(71) Applicant: CANON KABUSHIKI KAISHA, Tokyo (JP)

(72) Inventor: KENZOU SHIBUYA, Kanagawa (JP)

(21) Appl. No.: 19/318,190

(22) Filed: Sep. 3, 2025

(30) Foreign Application Priority Data
Sep. 10, 2024 (JP) 2024-156717

(51) Int. Cl. B41J 2/045; B41J 2/14

(52) U.S. Cl. CPC B41J 2/0455; B41J 2/0451; B41J 2/04555; B41J 2/14072; B41J 2/0458; B41J 2002/14491

(57) ABSTRACT

A liquid ejection head includes an ejection port configured to eject liquid, a heater configured to generate energy for ejecting liquid from the ejection port, an ejection switching element configured to be connected to the heater and to energize the heater, a current measurement element configured to have one end connected to a wiring that connects the heater and the ejection switching element and to measure a current flowing through the heater, and a measurement switching element configured to be connected to another end of the current measurement element and to energize the heater and the current measurement element, wherein switching of the ejection switching element to a conducting state and switching of the measurement switching element to a conducting state are performed mutually exclusively.

### BACKGROUND

### Field of the Technology

The present disclosure relates to a liquid ejection head that ejects liquid and to a liquid ejection apparatus.

### Description of the Related Art

A liquid ejection head including energy generation elements (hereinafter, referred to as heaters) that generate energy for ejecting liquid from ejection ports is known. In the case of this liquid ejection head, repeated ejection of liquid could cause deterioration of a heater, or excessive heat generated by driving the heaters with no liquid could lead to disconnection of a heater or wiring.

Japanese Patent Laid-Open No. 2001-121703 describes an inkjet recording head capable of detecting disconnection of such a heater or wiring. This inkjet recording head includes a sense wiring provided adjacent to a wiring of a heater, and a resistor for measuring the potential of the sense wiring. Because parasitic capacitance is present between the wiring of the heater and the sense wiring, the voltage value at terminal of the resistor changes via the parasitic capacitance due to electrostatic induction in accordance with a change in the value of the current flowing through the wiring of the heater. The voltage value at the resistor terminal is compared with a preset threshold, and when the voltage value exceeds the threshold, it is determined that disconnection has occurred in either the wiring of the heater or the sense wiring.

By detecting a change in the resistance value of a heater in accordance with a minute change in the current flowing through the heater, a deterioration state of the heater can be detected. However, in the case of the inkjet recording head described in Japanese Patent Laid-Open No. 2001-121703, the sense wiring is not connected to the heater, and is configured to indirectly measure the current flowing through the heater by using electrostatic induction. In such indirect measurement, while a significant change in the current flowing through the heater can be detected, a minute change in the current flowing through the heater cannot be detected, and therefore, it is difficult to detect the deterioration state of the heater.

### SUMMARY

The present disclosure is directed to providing a liquid ejection head capable of detecting a deterioration state of a heater.

According to some embodiments of the present disclosure, a liquid ejection head includes an ejection port configured to eject liquid, a heater configured to generate energy for ejecting liquid from the ejection port, an ejection switching element configured to be connected to the heater and to energize the heater, a current measurement element configured to have one end connected to a wiring that connects the heater and the ejection switching element and to measure a current flowing through the heater, and a measurement switching element configured to be connected to another end of the current measurement element and to energize the heater and the current measurement element, wherein switching of the ejection switching element to a conducting state and switching of the measurement switching element to a conducting state are performed mutually exclusively.

According to another aspect of the present disclosure, a liquid ejection head includes a heater configured to generate energy for ejecting liquid from an ejection port, and a current measurement element configured to measure a current flowing through the heater. In a case where the liquid is ejected, a power supply is grounded via the heater, and in a case where the current is measured, the power supply is grounded via a portion at which the heater and the current measurement element are connected.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of an inkjet recording apparatus to which the present disclosure is applicable.

FIG. 2 is a block diagram of a control system of a liquid ejection apparatus including a liquid ejection head according to a first embodiment of the present disclosure.

FIG. 3 is a schematic view of a recording element substrate of the liquid ejection head according to the first embodiment of the present disclosure.

FIG. 4 is a schematic view of an ejection electric circuit of the recording element substrate illustrated in FIG. 3.

FIG. 5 is a block diagram of an ejection element driving circuit of the recording element substrate illustrated in FIG. 3.

FIG. 6 is a block diagram of a current measurement circuit of the recording element substrate illustrated in FIG. 3.

FIG. 7 is a flowchart illustrating an example of a process for determining a deterioration state of a heater.

FIG. 8 is a schematic view of a recording element substrate of a liquid ejection head according to a second embodiment of the present disclosure.

FIG. 9 is a schematic view of an ejection electric circuit of the recording element substrate illustrated in FIG. 8.

### DESCRIPTION OF THE EMBODIMENTS

Hereinafter, various embodiments, features, and aspects of the present disclosure will be described in detail with reference to the drawings. However, the embodiments are merely examples, and the scope of the present disclosure is not limited to these embodiments.

### First Embodiment

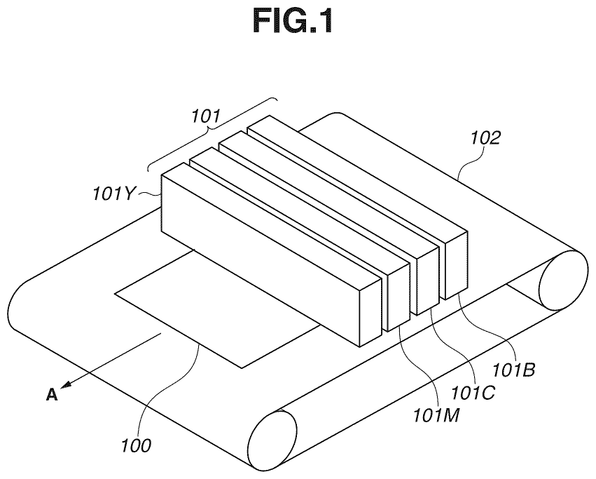

FIG. 1 is a schematic perspective view of an inkjet recording apparatus to which the present disclosure is applicable. The inkjet recording apparatus illustrated in FIG. 1 is a full-line type recording apparatus, and includes a liquid ejection head 101, which is a long-length inkjet recording head extending in the width direction of a recording medium 100. The liquid ejection head 101 includes four inkjet recording heads 101Y, 101M, 101C, and 101B that eject liquid such as ink. The recording medium 100 is conveyed in the direction indicated by an arrow A (a conveyance direction) by a conveyance unit 102 constituted by a conveyance belt, a conveyance roller, etc. The inkjet recording heads 101Y, 101M, 101C, and 101B are arranged in parallel along the conveyance direction, and eject yellow ink, magenta ink, cyan ink, and black ink, respectively, onto the recording medium 100. The recording apparatus to which the present disclosure is applicable is not limited to the full-line type recording apparatus. The present disclosure is also applicable to a serial-scan type recording apparatus, etc.

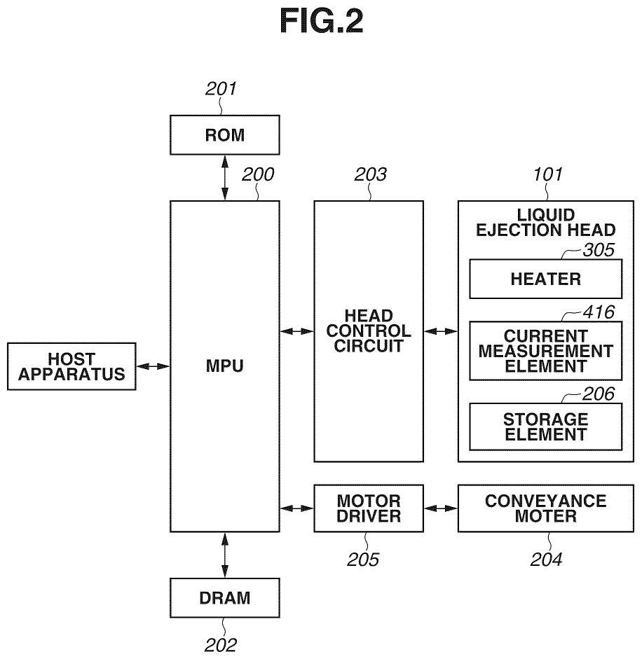

FIG. 2 is a block diagram of a control system of a liquid ejection apparatus including a liquid ejection head according to a first embodiment of the present disclosure. A micro-processing unit (MPU) 200 executes a control process, a data process, etc. of the liquid ejection apparatus. A read-only memory (ROM) 201 stores a program such as a processing procedure executed by the MPU 200. A random access memory (RAM) 202 is used as a work area or the like for executing the control process, the data process, etc. A head control circuit 203 controls operations of the liquid ejection head 101 (including operations of heaters 305, current measurement elements 416, etc.) in accordance with control signals or data from the MPU 200. For example, when liquid is ejected by the liquid ejection head 101, the MPU 200 supplies driving data of the heaters 305 to the head control circuit 203, and the head control circuit 203 drives the heaters 305 in accordance with the driving data. The MPU 200 controls a conveyance motor 204 of the conveyance unit 102 via a motor driver 205.

The liquid ejection head 101 includes a storage element 206, which is a storage unit in which information such as the resistance value of each heater 305 is stored in advance. For example, information including the resistance value (Rref [Ω]) and the specified value (±M [Ω]) of each heater 305 may be stored in the storage element 206 at the time of manufacturing of the liquid ejection head 101. Rref ±M [Ω] may be set as a specified range of the resistance value of each heater 305. Whether a heater 305 is in a deterioration state can be determined by determining whether the resistance value of this heater 305 is within the specified range. The details of the determination of the deterioration state will be described below. As the storage element 206, a fuse ROM, an electrically erasable programmable ROM (EEPROM), or the like can be used. However, the storage element 206 is not limited to these examples.

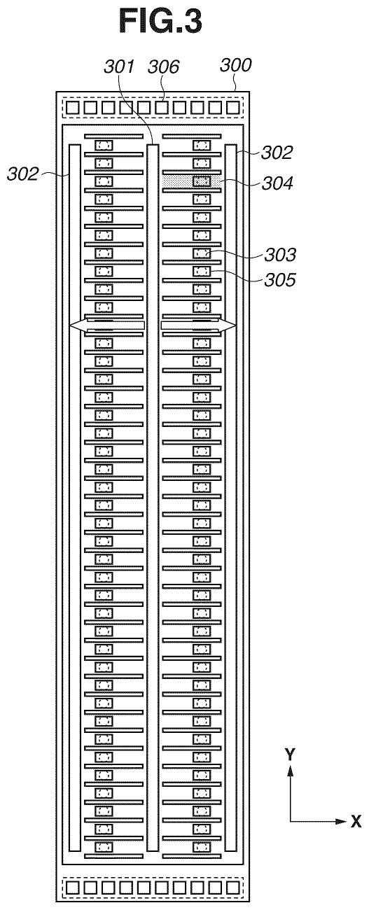

FIG. 3 is a schematic view of a recording element substrate 300 included in the liquid ejection head 101. An arrow Y indicates the longitudinal direction of the recording element substrate 300, and an arrow X indicates the lateral direction of the recording element substrate 300. The recording element substrate 300 has an ink supply port 301 extending in the direction indicated by the arrow Y in its central portion. A plurality of pressure chambers 304 are formed on both sides of the ink supply port 301. Each pressure chamber 304 communicates with an ejection port 303 for ejecting ink, and each heater 305 is provided in a region facing its corresponding ejection port 303. Each heater 305 generates energy for ejecting ink from its corresponding ejection port 303. The ink, which has been supplied from the ink supply port 301, is supplied to the individual pressure chambers 304, and subsequently, the remaining ink, which has not been ejected, is collected through an ink collection port 302.

Each heater 305 generates heat to cause the ink to foam in a pressure chamber 304, and the ink can be ejected from its corresponding ejection port 303 by using the foaming energy. An electrothermal conversion element (or a heat generation resistance element) can be used as the individual heater 305. The plurality of ejection ports 303 are arranged at predetermined intervals along the direction indicated by the arrow Y, and an ejection port array extending in the direction indicated by the arrow Y is formed by these ejection ports 303. The direction indicated by the arrow Y is a direction crossing (in the case of the present example, perpendicular to) the conveyance direction (the direction indicated by the arrow A) of the recording medium 100 illustrated in FIG. 1. A plurality of pads 306 are provided at both ends of the recording element substrate 300 in the direction indicated by the arrow Y. A selection data signal for selecting an ejection port 303 that ejects ink and a power supply voltage are supplied to the pads 306 from a recording apparatus main body. The liquid ejection head 101 can eject ink at any desired timing from an ejection port 303 selected based on the selection data signal.

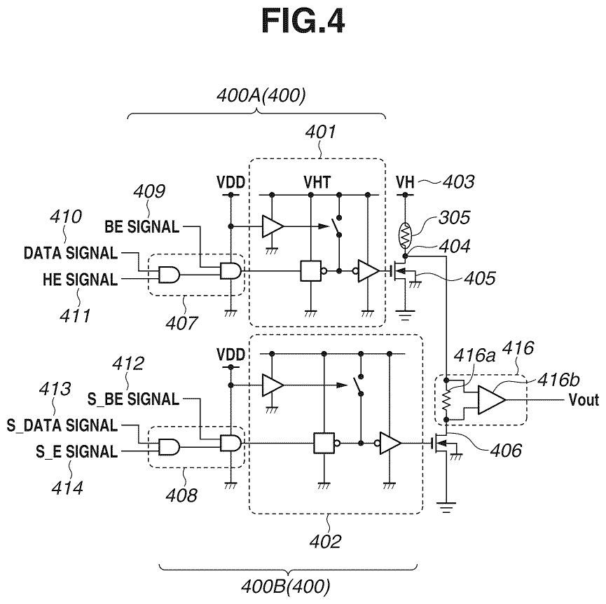

FIG. 4 is a schematic view of an ejection electric circuit 400 that is included in the recording element substrate 300 and that executes ejection and measurement. The ejection electric circuit 400 includes a heater 305, an ejection switching element 405 for controlling the heater 305, a current measurement element 416 for measuring a current flowing through the heater 305, and a measurement switching element 406 for controlling the current measurement element 416. One end of the heater 305 is connected to an ejection power supply (VH) 403, and the other end of the heater 305 is connected to the ejection switching element 405. Although only one ejection electric circuit 400 is illustrated in FIG. 4 for convenience, a plurality of ejection electric circuits 400 are actually provided, and ejection and measurement are executed by each ejection electric circuit 400.

The ejection switching element 405 is for energizing the heater 305, and is a metal-oxide-semiconductor field-effect transistor (MOSFET) switching element, for example. In this case, the other end of the heater 305 is connected to one terminal (source or drain) of the switching element, and the other terminal (source or drain) of the switching element is grounded. When the value of the voltage supplied to the gate terminal exceeds a threshold, the switching element transitions from a non-conducting state to a conducting state. When the ejection switching element 405 is brought into a conducting state, the ejection power supply 403 is grounded via the heater 305, and a current starts to flow from the ejection power supply 403 to the heater 305.

One end of the current measurement element 416 is connected to a wiring 404 that connects the heater 305 and the ejection switching element 405. The other end of the current measurement element 416 is connected to the measurement switching element 406. The measurement switching element 406 is for energizing the heater 305 and the current measurement element 416, and is a MOSFET switching element, for example. In this case, the other end of the current measurement element 416 is connected to one terminal (source or drain) of the switching element, and the other terminal (source or drain) of the switching element is grounded. When the voltage supplied to the gate terminal exceeds a threshold, the switching element transitions from a non-conducting state to a conducting state. When the ejection switching element 405 is in a non-conducting state and the measurement switching element 406 is in a conducting state, the ejection power supply 403 is grounded via the portion connecting the heater 305 and the current measurement element 416, and a current flows from the ejection power supply 403 to the heater 305 and the current measurement element 416.

The current measurement element 416 measures the current flowing through the heater 305. For example, the current measurement element 416 includes a resistor 416a and a differential amplifier 416b that amplifies the voltage generated across the resistor 416a. One end of the resistor 416a is connected to the wiring 404, and the other end of the resistor 416a is connected to the measurement switching element 406. When the ejection switching element 405 is in a non-conducting state and the measurement switching element 406 is in a conducting state, a current flows from the ejection power supply 403 to the heater 305 and the resistor 416a, and the differential amplifier 416b amplifies the voltage difference across the resistor 416a, and outputs a voltage Vout.

The ejection electric circuit 400 includes a heater driving unit 400A and a current measurement element driving unit 400B, in addition to the above configuration. The heater driving unit 400A includes an ejection level converter unit 401 and an ejection AND gate group 407. The ejection AND gate group 407 includes a plurality of AND gates. As input signals, an ejection block selection signal (BE) 409, an ejection data selection signal (DATA) 410, and an ejection time signal (HE) 411 are supplied to the ejection AND gate group 407. The output of the ejection AND gate group 407 is supplied to the ejection switching element 405 via the ejection level converter unit 401. The ejection level converter unit 401 is for driving of the ejection switching element 405, and converts the level of the output signal of the ejection AND gate group 407 to a desired signal level. The desired signal level is, for example, a signal level suitable to drive the MOSFET switching element described above.

During a period in which the ejection time signal (HE) 411 is applied to the ejection AND gate group 407, the ejection switching element 405 is in a conducting state, and a current flows through the heater 305.

When the current flowing through the heater 305 is denoted by I, this current I is expressed as “I=VH/R [A]” where “VH” indicates the voltage value [V] of the ejection power supply 403, and “R”indicates the resistance value [Ω] of the heater 305.

Further, when the Joule heat generated by the heater 305 is denoted by Q, this Joule heat Q is expressed as “Q=VH·I·T [J]” where “T” indicates the time in which the ejection time signal (HE) 411 is applied to the ejection AND gate group 407. The Joule heat Q generated by the heater 305 causes the ink to foam, and the foamed ink is ejected from the ejection port 303.

The current measurement element driving unit 400B includes a measurement level converter unit 402 and a measurement AND gate group 408. The measurement AND gate group 408 includes a plurality of AND gates. As input signals, a measurement block selection signal (S_BE) 412, a measurement data selection signal (S_DATA) 413, and a measurement signal (S_E) 414 are supplied to the measurement AND gate group 408. The output of the measurement AND gate group 408 is supplied to the measurement switching element 406 via the measurement level converter unit 402. The measurement level converter unit 402 is for driving of the measurement switching element 406, and converts the level of the output signal of the measurement AND gate group 408 to a desired signal level. The desired signal level is, for example, a signal level suitable to drive the MOSFET switching element described above.

When the measurement signal (S_E) 414 is supplied to the measurement AND gate group 408, the measurement switching element 406 is brought into a conducting state. When the measurement switching element 406 is brought into a conducting state while the ejection switching element 405 is in a non-conducting state, a current starts to flow through the heater 305 and the resistor 416a. When the current flowing through the heater 305 and the resistor 416a is denoted by Is, this current Is is expressed as “Is=VH/(R+Rs) [A]” where “Rs” indicates the resistance value in ohms [Ω] of the resistor 416a. When the voltage generated across the resistor 416a is denoted in volts by Vs, this voltage Vs is expressed as “Vs=Is·Rs [V]”. Assuming that the differential amplifier 416b amplifies the voltage across the resistor 416a by K times, the amplification factor of the differential amplifier 416b is denoted by K. The output voltage Vout of the differential amplifier 416b is expressed as Vout=K·Vs [V].

Based on the relationship described above, the resistance value R of the heater 305 is expressed as R=Rs·(K·VH−Vout)/Vout [Ω] (hereinafter, referred to as conversion equation 1 of the resistance value R), where VH, Rs, and K are all known design values. Therefore, by measuring the output voltage Vout of the differential amplifier 416b, the resistance value R of the heater 305 can be obtained based on the conversion equation 1 of the resistance value R. For example, assuming that the voltage VH of the ejection power supply 403 is 24.0 [V], the resistance value Rs of the resistor 416a is 10.0 [Ω], the amplification factor K of the differential amplifier 416b is 10 times, and the output voltage Vout of the differential amplifier 416b is 2.96 [V], 800.0 [Ω] can be obtained as the resistance value R of the heater 305, based on the conversion equation 1 of the resistance value R.

In the ejection electric circuit 400, the switching of the ejection switching element 405 to the conducting state and the switching of the measurement switching element 406 to the conducting state are performed mutually exclusively. Even if the ejection switching element 405 and the measurement switching element 406 are simultaneously brought into the conducting state, the potential of the wiring 404 becomes the same potential as the ground, and thus, the heater 305 generates the Joule heat Q, and no current flows through the current measurement element 416. That is, when the ejection operation by the heater 305 and the measurement operation by the current measurement element 416 simultaneously occur, the ejection electric circuit 400 prioritizes the ejection operation.

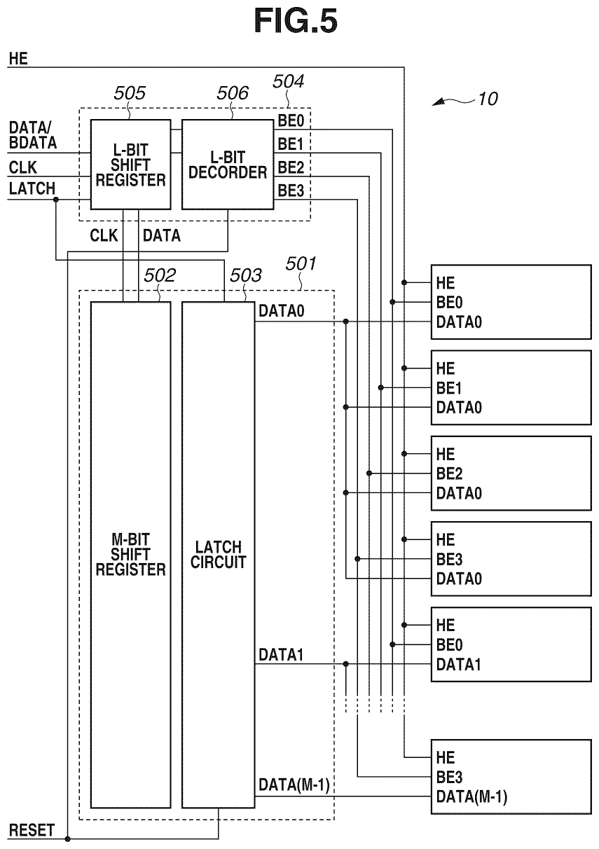

FIG. 5 is a block diagram illustrating a configuration of an ejection element driving circuit 10 included in the recording element substrate 300. The ejection element driving circuit 10 illustrated in FIG. 5 is configured to allocate the plurality of heaters 305 to four blocks and to drive these heaters 305. The ejection element driving circuit 10 includes an ejection data supply unit 501 and an ejection block selection unit 504.

The ejection data supply unit 501 includes an M-bit shift register 502 and a latch circuit 503. The M-bit shift register 502 stores ejection data DATA in synchronization with a transfer clock CLK. The latch circuit 503 temporarily holds the same bit data (M-bit data) of the M-bit shift register 502 in response to a data latch signal LATCH.

The ejection block selection unit 504 includes an L-bit shift register 505 and an L-bit decoder 506. The L-bit shift register 505 stores ejection block data BDATA in synchronization with the transfer clock CLK. The L-bit decoder 506 temporarily holds the same bit data (L (L=2)-bit data) of the L-bit shift register 505 in response to the data latch signal LATCH supplied. One of ejection block selection signals BE0 to BE3, one of ejection data selection signals DATA0 to DATA (M−1) corresponding to an ejection dot from the ejection data supply unit 501, and an ejection time signal HE are supplied to the ejection electric circuit 400 described above.

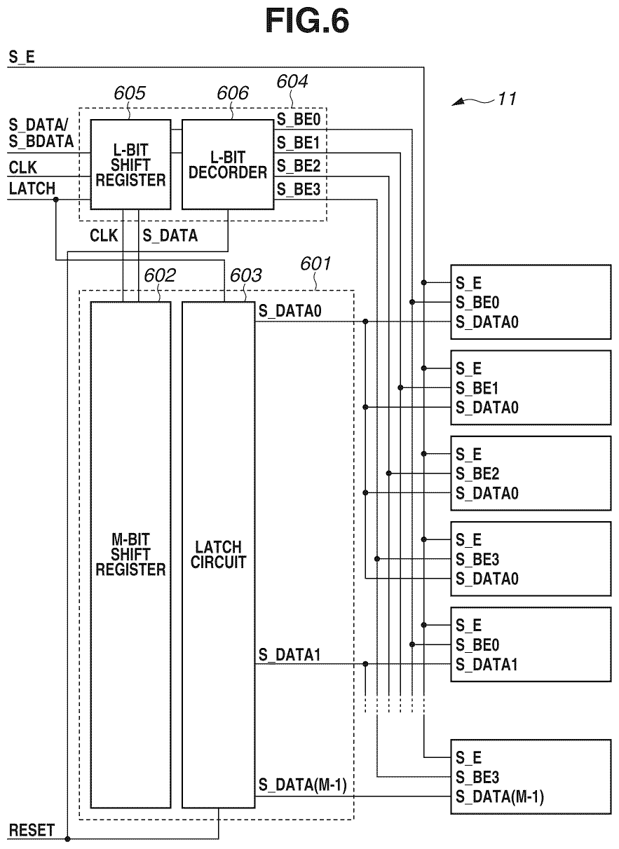

FIG. 6 is a block diagram illustrating a configuration of a current measurement circuit 11 included in the recording element substrate 300. The current measurement circuit 11 illustrated in FIG. 6 is configured to allocate the plurality of current measurement elements 416 to four blocks and to drive these current measurement elements 416. The current measurement circuit 11 includes a measurement data supply unit 601 and a measurement block selection unit 604.

The measurement data supply unit 601 includes an M-bit shift register 602 and a latch circuit 603. The M-bit shift register 602 stores measurement data S_DATA in synchronization with a transfer clock CLK. The latch circuit 603 temporarily holds the same bit data (M-bit data) of the M-bit shift register 602 in response to a data latch signal LATCH.

The measurement block selection unit 604 includes an L-bit shift register 605 and an L-bit decoder 606. The L-bit shift register 605 stores measurement block data S_BDATA in synchronization with the transfer clock CLK. The L-bit decoder 606 temporarily holds the same bit data (L (L=2)-bit data) of the L-bit shift register 605 in response to the data latch signal LATCH supplied. One of measurement block selection signals S_BE0 to S_BE3, one of measurement data selection signals S_DATA0 to S_DATA (M−1) corresponding to a measurement dot from the measurement data supply unit 601, and a measurement signal S_E are supplied to the ejection electric circuit 400 described above.

In the liquid ejection head 101 according to the present embodiment described above, when repeated ejection of ink has deteriorated a heater 305, the resistance value R of the heater 305 also changes accordingly. For example, the resistance value R of the heater 305 may increase due to damage to the heater 305 caused by periodic impacts or thermal load due to cavitation. However, the heater 305 deteriorates due to various factors, and the factors are not limited to the impacts and the thermal load due to the cavitation. In the present embodiment, the storage element 206 holds the resistance value (Rref [Ω]) and the specified value (±M [Ω]) of each heater 305 in advance. Whether a heater 305 is in a deterioration state can be determined by determining whether the resistance value R of this heater 305 is within the specified range (Rref ±M [Ω]).

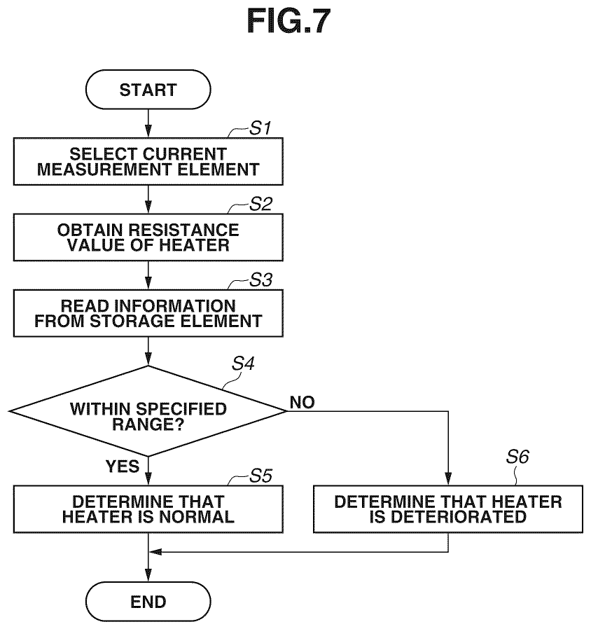

FIG. 7 is a flowchart illustrating an example of a process for determining a deterioration state of a heater. First, in step S1, the measurement data S_DATA and the measurement block data S_BDATA are supplied to the current measurement circuit 11 (see FIG. 6). The current measurement circuit 11 selects a measurement-target current measurement element 416 from the plurality of current measurement elements 416 based on the measurement data S_DATA and the measurement block data S_BDATA. Next, the measurement block selection signal (S_BE) 412 and the measurement data selection signal (S_DATA) 413 are supplied to the current measurement element driving unit 400B (see FIG. 4) corresponding to the measurement-target current measurement element 416. Next, the process proceeds to step S2.

In step S2, the measurement signal S_E is supplied to the current measurement circuit 11. The current measurement circuit 11 causes the measurement-target current measurement element 416 to measure a current in accordance with the measurement signal S_E. When the measurement signal (S_E) 414 is supplied to the measurement AND gate group 408 of the current measurement element driving unit 400B, the measurement switching element 406 is brought into a conducting state, and a current starts to flow through the heater 305 and the resistor 416a. The differential amplifier 416b outputs the voltage Vout after amplifying the voltage difference across the resistor 416a. The head control circuit 203 obtains the resistance value R of the heater 305 from the output voltage Vout of the differential amplifier 416b based on the conversion equation 1 of the resistance value R described above. Next, the process proceeds to step S3.

In step S3, the head control circuit 203 reads the resistance value (Rref [Ω]) and the specified value (±M [Ω]) of the heater stored in the storage element 206. Rref ±M [Ω] is a specified range of the resistance value of the heater 305. Next, the process proceeds to step S4.

In step S4, the head control circuit 203 determines whether the resistance value R of the heater 305 obtained in step S2 is within the specified range (Rref ±M [Ω]) of the resistance value of the heater 305 read in step S3.

If the determination result of step S4 is “YES”, the process proceeds to step S5. In step S5, the head control circuit 203 determines that the heater 305 is normal. If the determination result of step S4 is “NO”, the process proceeds to step S6. In step S6, the head control circuit 203 determines that the heater 305 has deteriorated.

According to the above-described process for determining a deterioration state of a heater 305, a change in the resistance value of a heater 305 in accordance with a minute change in the current flowing through the heater 305 can be detected. Thus, a deterioration state of the heater 305 can be detected. In a case where a heater 305 or the wiring is disconnected, the output voltage Vout of the differential amplifier 416b becomes zero. When the head control circuit 203 detects that the output voltage Vout of the differential amplifier 416b has become 0, the head control circuit 203 determines that the heater 305 or the wiring is disconnected.

In recent years, there has been a demand for products and manufacturing methods that place as little burden on the environment as possible. From the viewpoint of effective use of resources, used liquid ejection heads are subject to reusing or recycling. In the recycling procedure of used liquid ejection heads, after a used liquid ejection head is collected from a home, the used liquid ejection head is first subject to a preliminary inspection in a recycling factory. If the inspection result indicates any abnormality in a heater mounted on the liquid ejection head, the heater is not likely to be reused, and is therefore recycled or subject to disposal.

The resistance value of the individual heater 305 changes depending on the number of ink ejections and the usage status. Therefore, it is useful to determine whether the resistance value of the individual heater 305 is within an appropriate range when the liquid ejection head 101 is reused. By applying the above-described process for determining a deterioration state of the heater 305 to the used liquid ejection head recycling procedure, whether the liquid ejection head can be reused can be determined. For example, if the determination result in step S4 is “YES”, it is determined that the liquid ejection head can be reused. If the determination result in step S4 is “NO”, it is determined that the liquid ejection head cannot be reused. In this case, the head control circuit 203 or a control apparatus of recycling equipment may perform the determination process. In the latter case, for example, the liquid ejection head 101 is provided with an electrical contact for outputting the output of the differential amplifier 416b to an outside element. The output of the differential amplifier 416b is supplied to the control apparatus of the recycling equipment via the electrical contact of the liquid ejection head 101. In a case where the liquid ejection head 101 is small, the head control circuit 203 can perform the determination process. In a case where the liquid ejection head 101 is large, the control apparatus of the regeneration equipment can perform the determination process.

If the determination process is performed while the ink has run out, a current flows through the heater 305 and the current measurement element 416 without liquid. This leads to generation of excessive heat, which could damage the heater 305 and the wiring. Therefore, the process for determining a deterioration state of the heater 305 can be performed when the ink stored in the liquid ejection head 101 has decreased, that is, when the ink still remains (immediately before the ink runs out). For example, the head control circuit 203 performs the determination process when the ink has decreased, and stores the determination result in the storage element 206. The liquid ejection head 101 includes an electrical contact for outputting information stored in the storage element 206 to an outside element. The control apparatus of the recycling equipment can determine whether the liquid ejection head 101 is reusable by reading the information (the determination result) stored in the storage element 206 via the electrical contact of the liquid ejection head 101.

### Second Embodiment

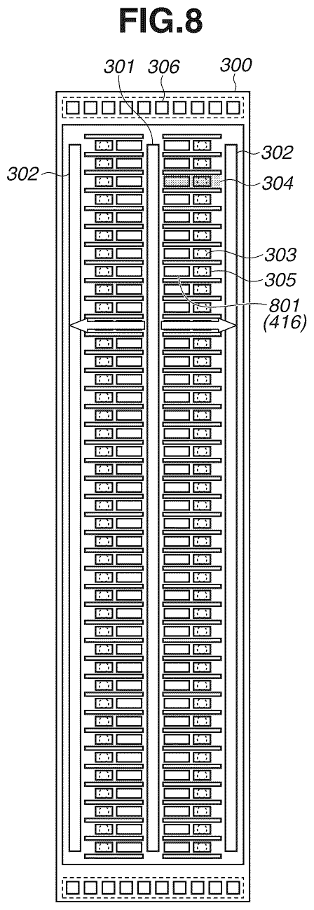

FIG. 8 is a schematic view of a recording element substrate constituting a liquid ejection head according to a second embodiment of the present disclosure. In FIG. 8, as with the arrows X and Y in FIG. 3, the direction of the arrow Y indicates the longitudinal direction of a recording element substrate 300, and the direction of the arrow X indicates the lateral direction of the recording element substrate 300.

A liquid ejection head 101 according to the present embodiment is the same as that described in the first embodiment, except that the resistor 416a of the current measurement element 416 is replaced by an element 801. The same components as those according to the first embodiment are denoted by the same reference characters, and detailed description of these components will be omitted.

The individual element 801 functions as a resistor used when a current is measured, and also functions as an electrothermal conversion element (a heater) that heats ink. Each element 801 is disposed between an ink supply port 301 and a heater 305. In the ink flow direction, each element 801 is disposed on the upstream side of its corresponding heater 305, and can heat the ink supplied to the corresponding heater 305 on the upstream side.

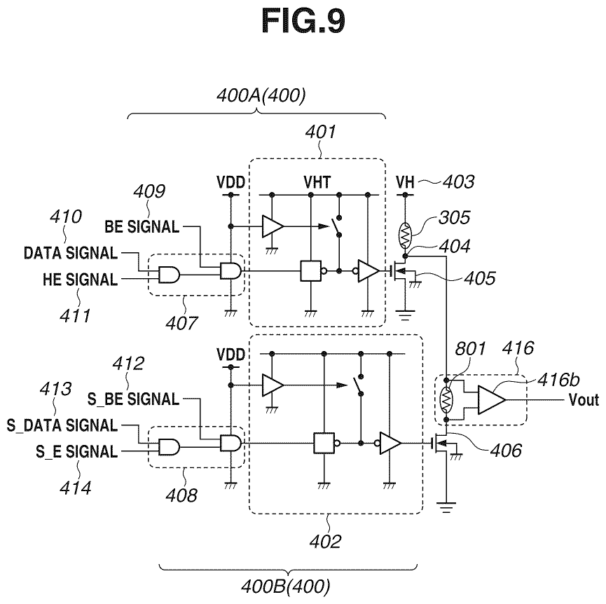

FIG. 9 is a schematic view of an ejection electric circuit that is included in the recording element substrate illustrated in FIG. 8 and that executes ejection and measurement. Although an ejection electric circuit 400 provided for one heater 305 is illustrated in FIG. 9 for convenience, the ejection electric circuit 400 illustrated in FIG. 9 is actually provided per heater 305.

One end of the element 801 is connected to a wiring 404 connecting the heater 305 and an ejection switching element 405, and the other end of the element 801 is connected to a measurement switching element 406. A differential amplifier 416b amplifies the voltage difference across the element 801, and outputs a voltage Vout.

During a period in which an ejection time signal (HE) 411 is applied, the ejection switching element 405 is in a conducting state. When the ejection switching element 405 is brought into a conducting state, a current starts to flow through the heater 305, and the heater 305 generates Joule heat Q1 (Q1=VH·I·T [J]). This causes the ink to foam, and the foamed ink is ejected from the ejection port 303.

When a measurement signal S_E is applied, the measurement switching element 406 is brought into a conducting state. When the measurement switching element 406 is brought into a conducting state while the ejection switching element 405 is in a non-conducting state, a current starts to flow through the heater 305 and the element 801, and a voltage (Vs=Is·Rs [V]), where Rs represents the resistance value of the element 801, is generated across the element 801. Because the differential amplifier 416b amplifies the voltage across the element 801 by K times, the output voltage of the differential amplifier 416b is expressed as “Vout=K·Vs [V]”. The resistance value of the heater 305 is expressed as “R=Rs·(K·VH−Vout)/Vout [Ω]”. This equation is the same as the conversion equation 1 of the resistance value R described above.

The liquid ejection head 101 according to the present embodiment produces the following advantageous effects, in addition to the advantageous effects described in the first embodiment.

When the measurement switching element 406 is held in a conducting state for a period of time Tb [seconds], the heater 305 generates Joule heat Q2 (Q2=R·Is²·Tb [J]), and the element 801 generates Joule heat Qs (Qs=Rs·Is²·Tb [J]). When the heater 305 and the element 801 heat the ink, the viscosity of the ink in a pressure chamber 304 decreases. As a result, the circulation of the ink and the ejection operation, in which the ejection switching element 405 is brought into a conducting state to eject ink from the ejection port 303, can be suitably performed. In particular, by disposing the element 801 on the upstream side of the heater 305, the ink supplied to the heater 305 can be heated, and thus, the ejection operation can be performed more suitably. Note that the above-described Joule heats and resistance values have the relationships Qs<Q2<Q1 and Rs<R, and both Qs and Q2 are set to temperatures at which no bubbles are generated.

In addition, normally, the resistor for measuring the current and the electrothermal conversion element (heater) for heating the ink are separately provided. According to the present embodiment, the element 801 has a function as a resistor for measuring the current and a function as an electrothermal conversion element (heater) for heating ink. Therefore, the number of elements used in the recording element substrate 300 can be reduced.

The applications and modifications described in the first embodiment can also be made to the liquid ejection head 101 according to the present embodiment.

According to the present disclosure, a change in the resistance value of a heater in accordance with a minute change in the current flowing through the heater can be detected, and thus, a deterioration state of the heater can be detected.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-156717, filed Sep. 10, 2024, which is hereby incorporated by reference herein in its entirety.

What is claimed is:

1. A liquid ejection head comprising:
an ejection port configured to eject liquid;
a heater configured to generate energy for ejecting liquid from the ejection port;
an ejection switching element configured to be connected to the heater and to energize the heater;
a current measurement element configured to have one end connected to a wiring that connects the heater and the ejection switching element and to measure a current flowing through the heater; and
a measurement switching element configured to be connected to another end of the current measurement element and to energize the heater and the current measurement element,
wherein switching of the ejection switching element to a conducting state and switching of the measurement switching element to a conducting state are performed mutually exclusively.

2. The liquid ejection head according to claim 1, wherein the current measurement element includes a resistor and a differential amplifier that amplifies a voltage generated across the resistor.

3. The liquid ejection head according to claim 2, wherein one end of the resistor is connected to the wiring that connects the heater and the ejection switching element, and a current flows through the heater and the resistor in a case where the ejection switching element is in a non-conducting state and the measurement switching element is in a conducting state.

4. The liquid ejection head according to claim 3, comprising an electrical contact configured to provide an output of the differential amplifier to an outside element.

5. The liquid ejection head according to claim 2, wherein the resistor heats the liquid.

6. The liquid ejection head according to claim 5, comprising a pressure chamber configured to communicate with the ejection port and to receive the liquid,
wherein the pressure chamber is provided with the heater and the resistor, and the resistor is disposed on an upstream side of the heater in a flow direction of the liquid.

7. The liquid ejection head according to claim 1, comprising:
a plurality of heaters, and a plurality of current measurement elements; and
a current measurement circuit configured to select a measurement-target current measurement element from the plurality of current measurement elements in accordance with an input signal.

8. A liquid ejection head comprising:
a heater configured to generate energy for ejecting liquid from an ejection port; and
a current measurement element configured to measure a current flowing through the heater,
wherein, in a case where the liquid is ejected, a power supply is grounded via the heater, and
wherein, in a case where the current is measured, the power supply is grounded via a portion at which the heater and the current measurement element are connected.

9. A liquid ejection apparatus comprising:
a liquid ejection head configured to include an ejection port configured to eject liquid, a heater configured to generate energy for ejecting liquid from the ejection port, an ejection switching element configured to be connected to the heater and to energize the heater, a current measurement element configured to have one end connected to a wiring that connects the heater and the ejection switching element and to measure a current flowing through the heater, and a measurement switching element configured to be connected to another end of the current measurement element and to energize the heater and the current measurement element; and
a head control circuit configured to control an operation of the liquid ejection head,
wherein switching of the ejection switching element to a conducting state and switching of the measurement switching element to a conducting state are performed mutually exclusively, and
wherein the head control circuit obtains a resistance value of the heater based on an output of the current measurement element, and determines that the heater is normal in a case where the obtained resistance value of the heater is within a predetermined range, and determines that the heater has deteriorated in a case where the obtained resistance value of the heater is out of the predetermined range.

10. The liquid ejection apparatus according to claim 9, comprising a storage element configured to hold information indicating whether the heater is normal or deteriorated.

11. The liquid ejection apparatus according to claim 10, wherein the liquid ejection head includes an electrical contact for outputting information held in the storage element to an outside element.
